(19) United States
(12) Patent Application Publication
(10) Pub. No.: US 2009/0316027 A1
(43) Pub. Date: Dec. 24, 2009

(54) IMAGE ACQUISITION DEVICE WITH ANTENNA MODULE

(75) Inventor: Chien-Hsing Fang, Taichung City (TW)

Correspondence Address: STEVENS & SHOWALTER LLP, 7019 CORPORATE WAY, DAYTON, OH, 45459-4238, US

(73) Assignee: SMART APPROACH CO., LTD., Chutung (TW)

(21) Appl. No.: 12/109,366

(22) Filed: Apr. 25, 2008

(51) Int. Cl. H04N 5/335

(52) U.S. Cl. 348/294; 348/207.99; 348/E05.091

(57) ABSTRACT

An image acquisition device with an antenna module is described. A signal transmission line is electrically connected to an image acquisition unit and the antenna module, so as to deliver an image acquired by the image acquisition unit and a signal received by the antenna module via the signal transmission line.

### BACKGROUND OF THE INVENTION

1. Field of Invention

The present invention relates to an image acquisition device, and more particularly to an image acquisition device with an antenna module.

2. Related Art

Car sellers used to lay emphasis on the horsepower and performance of a car when selling the car. However, with the development of techniques, the cars purchased by general consumers are almost the same in performance. Therefore, more and more car sellers begin to emphasize equipping the car with a variety of high-tech products. Some emphasize providing the car with multiple charge couple devices (CCDs) to assist in driving video. Some emphasize providing the car with multiple antennae respectively for wireless sending/receiving of a Digital Video Broadcasting (DVB), a Global Positioning System (GPS) or a Global System for Mobile Communication (GSM). However, too many technical equipments used in the car always result in too many lines that seem disorderly and unsystematic, which causes an increase in the overall cost and power consumption of the car due to respective and separate operations of various technical equipments in additional to the difficulty in arranging the lines.

### SUMMARY OF THE INVENTION

The present invention is directed to an image acquisition device with an antenna module, which is capable of avoiding the difficulty in arranging the lines and meanwhile the increase in the overall cost and power consumption.

The image acquisition device with an antenna module disclosed in the present invention includes an image acquisition unit, an antenna module, and a signal transmission line. The image acquisition unit is used for acquiring an image. The antenna module has at least one antenna unit for sending/receiving at least one signal. The signal transmission line includes a first signal line and a second signal line. The first signal line is electrically connected to the image acquisition unit, such that the image acquisition unit delivers the image via the first signal line. The second signal line is electrically connected to the antenna module, such that the antenna module delivers the signal via the second signal line.

The image acquisition device with an antenna module disclosed in the present invention further includes a system host and a display interface. The system host is electrically connected to the signal transmission line, and has a processor for analyzing the image and the signal delivered by the signal transmission line after being received by the system host. The display interface is electrically connected to the system host, such that the processor presents the analyzed image and the signal on the display interface. The system host further includes a data storage unit. The data storage unit is electrically connected to the processor, for storing the image and the signal.

The image acquisition device with an antenna module of the present invention integrates the image acquisition unit and the antenna module to achieve the effect of reducing the cost, and at the same time may further use the functions of the image acquisition unit and the antenna module simultaneously to achieve the functions such as driving recording in addition to the antenna function and image acquisition function it originally has. On the other hand, the image acquisition device with an antenna module of the present invention may reduce the problem of arranging the lines through integrating the first signal line and the second signal line into the signal transmission line.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an image acquisition device with an antenna module according to a first embodiment of the present invention;

FIG. 2 is a schematic radial cross-sectional view of a signal transmission line according to the present invention;

FIG. 3 is another schematic radial cross-sectional view of the signal transmission line according to the present invention; and

FIG. 4 is a schematic view of an image acquisition device with an antenna module according to a second embodiment of the present invention.

### DETAILED DESCRIPTION OF THE INVENTION

The features and practices of the present invention are hereby illustrated in detail below in combination with the drawings.

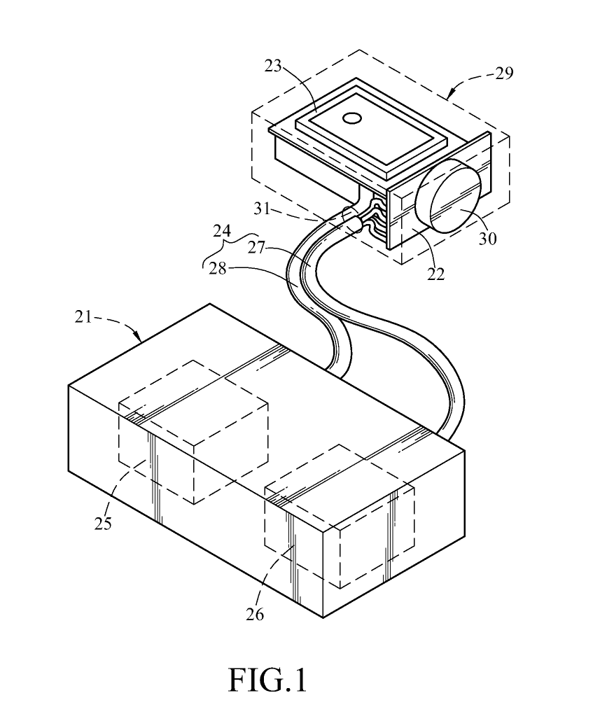

Referring to FIG. 1, a schematic view of an image acquisition device with an antenna module according to a first embodiment of the present invention is shown. The image acquisition device with an antenna module includes an image acquisition unit 22, an antenna module 23, and a signal transmission line 24.

The image acquisition unit 22 is used for acquiring an image. The image acquisition unit 22 may be a charge couple device (CCD), but it certainly may also be a complementary metal oxide semiconductor (CMOS).

The antenna module 23 has at least one antenna unit for sending/receiving at least one signal. The antenna module 23 includes at least one of a Digital Video Broadcasting ( DVB )antenna, a Global Positioning System ( GPS )antenna, a Global System for Mobile Communications ( GSM ) antenna, and a radio frequency (RF) antenna.

The signal transmission line 24 includes a first signal line 27 and a second signal line 28. The first signal line 27 is electrically connected to the image acquisition unit 22, such that the image acquisition unit 22 delivers the image via the first signal line 27. The first signal line 27 is, but not limited to, a twisted line.

The first embodiment of the present invention further includes a system host 21 having a processor 25, and the processor 25 has multiplexing capabilities such as operating and analyzing. The system host 21 may further include a data storage unit 26 electrically connected to the processor 25, for storing the image and the signal. The data storage unit 26 may be a hard disk, a universal serial bus (USB) disk, or another data storage device such as a memory card.

The first signal line 27 is electrically connected with the system host 21 through a universal serial bus (USB) interface, but it certainly may also be electrically connected with the system host 21 through other connection interfaces. The second signal line 28 has one end electrically connected to the antenna module 23 and the other end electrically connected to the system host 21, such that the antenna module 23 delivers the signal via the second signal line 28 to the processor 25 to be analyzed. The second signal line 28 is, but not limited to, a coaxial signal line. The second signal line 28 is electrically connected with the system host 21 through an RF connection interface, but it certainly may also be electrically connected with the system host 21 through other connection interfaces.

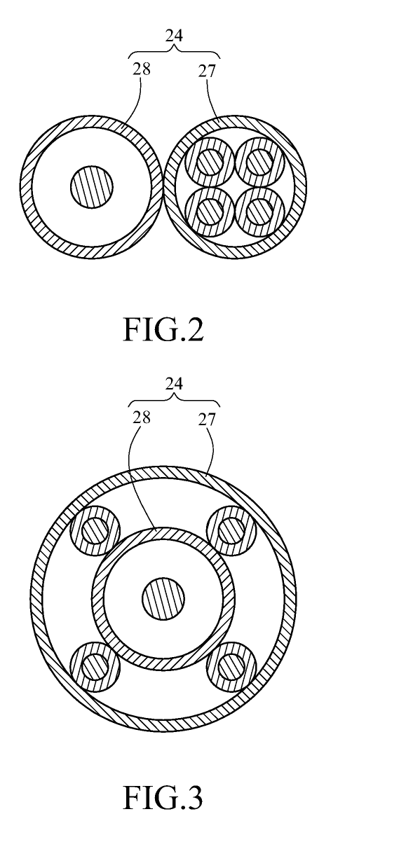

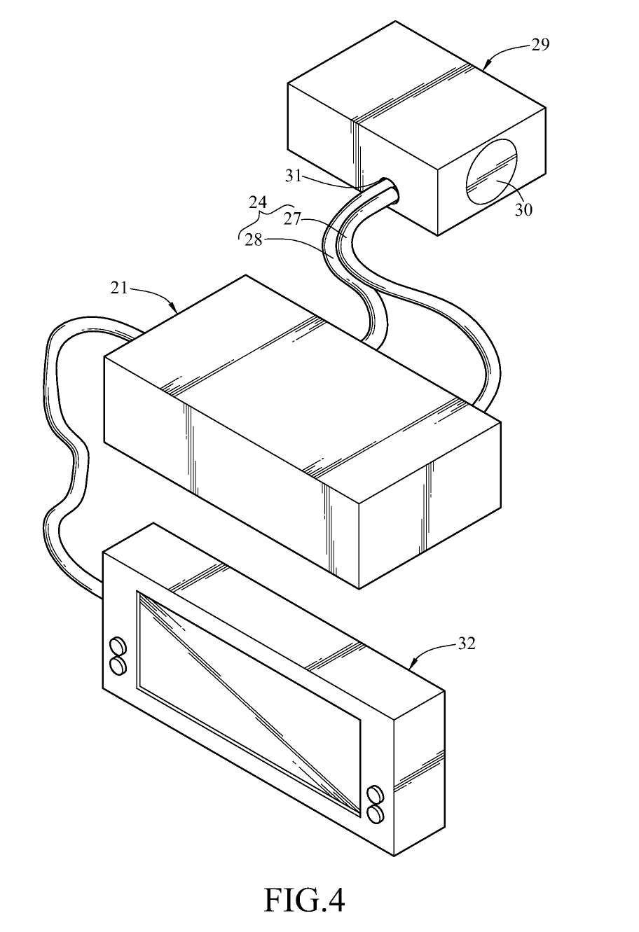

Referring to FIG. 2, a schematic radial cross-sectional view of the signal transmission line according to the present invention is shown. The signal transmission line 24 is a parallel line formed by parallelly arranging the first signal line 27 and the second signal line 28, so as to integrate the lines to simplify the lines required to be used. Referring to FIG. 3, another schematic radial cross-sectional view of the signal transmission line according to the present invention is shown. The signal transmission line 24 of the present invention may also be a single multi-core line made by embedding the second signal line 28 in the first signal line 27 or in another manner, so as to integrate the lines to simplify the lines required to be used.

The image acquisition device with an antenna module according to the first embodiment of the present invention further includes a housing 29. The image acquisition unit 22 and the antenna module 23 are disposed in the housing 29. A first hole 30 is opened in the housing 29, such that the image acquisition unit 22 acquires an image outside through the first hole 30. The first hole 30 is further provided with a transparent material, such as glass and plastics, for protecting the image acquisition unit 22. At least one second hole 31 is further opened in the housing 29, such that the signal transmission line 24 passes through the second hole 31, and has its one end electrically connected to the image acquisition unit 22 and the antenna module 23 respectively and the other end electrically connected to the system host 21.

In the image acquisition device with an antenna module according to the first embodiment of the present invention, through integrating the first signal line 27 and the second signal line 28 by the signal transmission line 24, the lines required to be used are simplified to reduce the problem of arranging the lines. On the other hand, the originally separately operated image acquisition unit 22 and the antenna module 23 are integrated, such that the functions such as driving recording may be achieved by operating the functions of the image acquisition unit 22 and the antenna module 23 simultaneously, in addition to the original antenna function and image acquisition function.

Referring to FIG. 4, a schematic view of an image acquisition device with an antenna module according to a second embodiment of the present invention is shown. The image acquisition device with an antenna module according to the second embodiment of the present invention is similar to that of the first embodiment, except that the second embodiment of the present invention further includes a display interface 32 electrically connected to the system host 21, such that the processor 25 presents the analyzed image and signal on the display interface 32. The display interface 32 may be a device capable of presenting images, for example, a liquid crystal display.

In the image acquisition device with an antenna module according to the second embodiment of the present invention, the signal received by the antenna module 23 is presented on the display interface 32 after being analyzed by the processor 25. For example, the DVB signals or the global satellite positioning signals etc. are received to allow the user to watch the DVB or the current driving navigation route in real time. On the other hand, the acquired image is presented on the display interface 32 after the processor 25 analyzes the signal received by the image acquisition unit 22. For example, when parking or backing a car, the distances between the cars are displayed on the display interface, and the function of a driving image recorder is also achieved by combining the signal of the antenna module 23 and the image of the image acquisition unit 22 simultaneously.

What is claimed is:

1. An image acquisition device with an antenna module, comprising:
an image acquisition unit, for acquiring an image;
an antenna module, having at least one antenna unit for sending/receiving at least one signal; and
a signal transmission line, comprising:
a first signal line, electrically connected to the image acquisition unit, such that the image acquisition unit delivers the image via the first signal line; and
a second signal line, electrically connected to the antenna module, such that the antenna module delivers the signal via the second signal line.

2. The image acquisition device with an antenna module as claimed in claim 1, further comprising a system host, wherein the system host is electrically connected to the signal transmission line, and has a processor for analyzing the image and the signal delivered by the signal transmission line after being received by the system host.

3. The image acquisition device with an antenna module as claimed in claim 2, further comprising a display interface, wherein the display interface is electrically connected to the system host, such that the processor presents the resolved image and the resolved signal on the display interface.

4. The image acquisition device with an antenna module as claimed in claim 2, wherein the system host comprises a data storage unit electrically connected to the processor and used for storing the image and the signal.

5. The image acquisition device with an antenna module as claimed in claim 1, wherein the first signal line is a twisted line.

6. The image acquisition device with an antenna module as claimed in claim 1, wherein the second signal line is a coaxial signal line.

7. The image acquisition device with an antenna module as claimed in claim 1, wherein the signal transmission line is a parallel line formed by parallelly arranging the first signal line and the second signal line.

8. The image acquisition device with an antenna module as claimed in claim 1, wherein the signal transmission line is a single multi-core line made by embedding the first signal line in the second signal line.

9. The image acquisition device with an antenna module as claimed in claim 1, wherein the image acquisition unit is a charge couple device (CCD) or a complementary metal oxide semiconductor (CMOS).

10. The image acquisition device with an antenna module as claimed in claim 1, wherein the antenna module is at least one of a Digital Video Broadcasting (DVB) antenna, a Global Positioning System (GPS) antenna, a Global System for Mobile Communication (GSM) antenna and a wireless frequency modulation (FM) system antenna.

11. The image acquisition device with an antenna module as claimed in claim 1, further comprising a housing for disposing the image acquisition unit and the antenna module therein.

12. The image acquisition device with an antenna module as claimed in claim 11, wherein the housing body is formed with a first hole, such that the image acquisition unit acquires an image through the first hole.

13. The image acquisition device with an antenna module as claimed in claim 12, wherein the hole is provided with a transparent material for protecting the image acquisition unit.

14. The image acquisition device with an antenna module as claimed in claim 11, wherein the housing body is formed with at least one second hole, such that the signal transmission line passes through the second hole and has one end electrically connected to the image acquisition unit and the antenna module respectively and the other end electrically connected to the system host.
